(19) United States
(12) Patent Application Publication
(10) Pub. No.: US 2021/0173319 A1
(43) Pub. Date: Jun. 10, 2021

(54) PRETREATMENT COMPOSITIONS

(71) Applicant: Hewlett-Packard Development Company, L.P., Spring, TX (US)

(72) Inventors: Inna Tzomik, Nes Ziona (IL); Katty Noorany, Nes Ziona (IL); Gleb Romantcov, Nes Ziona (IL)

(21) Appl. No.: 16/771,184

(22) PCT Filed: Jan. 18, 2018
(86) PCT No.: PCT/US2018/014228

§ 371 Date: Jun. 9, 2020

(51) Int. Cl. G03G 9/135; C08J 5/18; C08J 7/043; C08J 5/12; C09J 5/02; G03G 9/125

(52) U.S. Cl. CPC G03G 9/1355; C08J 5/18; C08J 7/043; C08J 5/122; C09J 2479/023; G03G 9/125; C08J 2367/02; C09J 2467/006; C09J 5/02

(57) ABSTRACT

There is provided a method of forming a seam between a first region of polymer film and a second region of polymer film. The method comprises pretreating a first region of a polymer film by applying a pretreatment composition comprising solid lubricant particles onto the first region of polymer film; priming the pretreated polymer film with a primer; electrophotographically printing an electrophotographic ink composition onto the primed polymer film to form a printed image; and solvent-bonding the pretreated first region of polymer film to the second region of polymer film to form a seam.

### BACKGROUND

Polymer films are often used in the packaging industry. As well as being used to manufacture product packaging, polymer films may also be used to produce labels for application to product packaging. For instance, opposing edges of a sheet of polymer film may be sealed together to form a seam. The resulting sleeve may be heat shrunk to the contours of a container to provide a “shrink sleeve” for the container.

In many instances, it may be desirable to print, for example, designs, text or on the polymer films. Such printed films may be used to provide information on the contents of the packaging. For example, shrink sleeves bearing product logos, trademarks, slogans, designs and product information may be heat shrunk to containers as labels. Various printing techniques may be used to print on such polymer films, including, for example, electrophotographic printing.

### DETAILED DESCRIPTION

Before the present disclosure is disclosed and described, it is to be understood that this disclosure is not limited to the particular method steps and materials disclosed herein because such method steps and materials may vary. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “liquid electrostatic composition” or “liquid electrophotographic composition” generally refers to a composition that is suitable for use in an electrostatic printing process, sometimes also termed an electrophotographic printing process.

As used herein, “co-polymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

Unless the context dictates otherwise, the terms “acrylic” and “acrylate” refer to any acrylic or acrylate compound. For example, the term “acrylic” includes acrylic and methacrylic compounds unless the context dictates otherwise. Similarly, the term “acrylate” includes acrylate and methacrylate compounds unless the context dictates otherwise.

As used herein, “electrostatic printing” or “electrophotographic printing” refers to the process that provides an image that is transferred from a photo imaging substrate either directly, or indirectly via an intermediate transfer member, to a print substrate. As such, the image is not substantially absorbed into the photo imaging substrate on which it is applied. Additionally, “electrophotographic printers” or “electrostatic printers” refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g. an electric field having a field gradient of 50-400V/μm, or more, in some examples 600-900V/μm, or more, in some examples 1000 V/cm or more, or in some examples 1500 V/cm or more.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of moulding. In the present disclosure, “melt flow rate” is measured per ASTM D1238-04c Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the electrostatic composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @140° C., units are mPa-s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

If a standard test is mentioned herein, unless otherwise stated, the version of the test to be referred to is the most recent at the time of filing this patent application.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “transparent” is used to describe a composition that allows light to pass through it.

Concentrations, amounts, and other numerical data may be expressed or presented in this disclosure in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used in this disclosure, weight % (wt %) values are to be taken as referring to a weight-for-weight (w/w) percentage of solids in the composition, and not including the weight of any carrier liquid present.

Unless otherwise stated, any feature described herein can be combined with any aspect or any other feature described herein.

In an aspect, there is provided a method of forming a seam between a first region of polymer film and a second region of polymer film. The method comprises pretreating a first region of a polymer film by applying a pretreatment composition comprising solid lubricant particles onto the first region of polymer film; priming the pretreated polymer film with a primer; electrophotographically printing an electrophotographic ink composition onto the primed polymer film to form a printed image; and solvent-bonding the pretreated first region of polymer film to the second region of polymer film to form a seam.

In a further aspect, there is provided an electrophotographic pretreatment composition comprising solid lubricant particles, a charge adjuvant, and a liquid carrier. The solid lubricant particles comprise at least one fatty acid ester of a polyol.

Polymer films may be sealed by solvent-bonding. With solvent-bonding, a seaming solvent may be applied to selected areas of the polymer film to soften (e.g. by partially dissolving) the polymer in the selected areas. The softened polymer can act as an adhesive so that, when an untreated area of polymer film is pressed against the soften polymer, a seam can be formed. In the case of a sheet of polymer film, seaming solvent may be applied, for example, along an edge region of the sheet to soften the polymer at that region. When an opposing edge region of the sheet is pressed against the softened polymer, a seam can be formed, producing a sleeve from the sheet of polymer film. This sleeve may be heat shrunk to conform to the shape of a container, for example, as a heat shrink label.

When electrophotographically printing images onto polymer films, primers can be used to improve adhesion of the printed ink on the polymer film substrate. A suitable primer may be a primer containing polyethylene imine. The present inventors, however, have found that it can be difficult to seal such primed polymer films. Without wishing to be bound by any theory, this is believed to be because the primer can interfere with the seaming process, reducing the efficacy of seam formation.

In the present disclosure, the present inventors have found that, by applying a pretreatment composition comprising a solid lubricant particles to a polymer film, it may be possible to inhibit deposition of the primer onto the pretreated region(s) of the polymer film. Thus, when the pretreated region of polymer film is seamed to a second region of polymer film, the risk of the primer interfering with the seaming process may be reduced, as the seam may be formed between e.g. primer-free areas of the film.

### Pretreatment Composition

The pretreatment composition comprises solid lubricant particles. The solid lubricant may be any lubricant that is capable of repelling or inhibiting the deposition of the primer. In one example, the solid lubricant particles may comprise a fluoropolymer. In other examples, the solid lubricant particles may comprise at least one ester of a fatty acid and a polyol. Suitable fatty acids may be C₆ to C₂₅ fatty acids, for example, C₆-C₂₂ fatty acids or C₈ to C₂₀ fatty acids. In some examples, the fatty acid may be a C₈ to C₁₈ fatty acid, for instance, a C₁₀ to C₁₈ fatty acid or a C₁₂ to C₁₈ fatty acid. In some examples, the fatty acid may be a C₁₄ to C₁₈ fatty acid or C₁₆ to C₁₈ fatty acid. Examples of suitable fatty acids include myristoleic acid, palmitoleic acid, sapienic acid, oleic acid, elaidic acid, vaccenic acid, linoleic acid, linoelaidic acid, alpha-linolenic acid, arachidonic acid, eicosapentaenoic acid, erucic acid, ricinoleic acid and docosahexaenoic acid. Other examples include caprylic acid, capric acid, lauric acid, myristic acid, palmitic acid, stearic acid, arachidic acid, behenic acid, lignoceric acid and cerotic acid.

The fatty acid may include unsaturated C═C bonds or may be fully saturated (e.g. by hydrogenation). In one example, the fatty acid is a saturated fatty acid. In one example, the fatty acid may be stearic acid or ricinoleic acid (e.g. hydrogenated ricinoleic acid).

The polyol may be any suitable polyol. The polyol may have 2 or more hydroxyl groups. For example, the polyol may have 2 to 6 hydroxyl groups, for example, 3 to 4 hydroxyl groups. Examples of suitable polyols include glycerol and pentaerythritol.

In some examples, the fatty acid ester of a polyol may be a mono-, di- or tri-ester of a polyol.

Examples of suitable fatty acid esters of polyols include hydrogenated castor oil, glycerol monostearate, pentaerythritol monostearate and pentaerythritol distearate. In one example, the ester is a hydrogenated castor oil. In some examples a mixture of two or more esters may be employed.

The pretreatment composition may be transparent. By transparent, it is meant that the underlying substrate is visible through the applied pretreatment composition. In some examples, the pretreatment composition may be devoid of colorant.

The pretreatment composition may be applied using any suitable method. For example, the pretreatment composition may be applied by coating, spraying, brushing, printing (e.g. electrophotographic printing) or using an injection nozzle. In one example, the pretreatment composition may be applied by electrophotographic printing.

The pretreatment composition may be applied only to the first region of the polymer film. The first region of the polymer film may be along an edge region of the polymer film. In some examples, the pretreatment composition may only be applied along an edge region of the polymer film. The pretreated region of polymer film may be bonded to another region of polymer film and, thus, subsequently form a seam as will be described in further detail below.

In some examples, the pretreatment composition is an electrophotographic pretreatment composition. The electrophotographic pretreatment composition may comprise solid lubricant particles as described herein. The solid lubricant particles may be present in an amount of up to 100 weight %, for example, up to 99 weight % based on the total weight of solids in the composition. For example, the solid lubricant particles may be present in an amount of at least 70 to 100%, for instance, 80 to 99.5% or 90 to 99% by weight of the total weight of solids in the composition.

Where the pretreatment composition is an electrophotographic pretreatment composition, the composition comprises a charge adjuvant and a liquid carrier. In some examples, the electrophotographic pretreatment composition may also include a charge director. In some examples, the electrophotographic pretreatment composition may further include a thermoplastic polymer resin.

Any suitable electrophotographic printing process may be used to electrophotographically print the electrophotographic pretreatment composition onto the polymer film. In some examples, the polymer film is corona treated prior to being electrophotographically printed with the electrophotographic pretreatment composition. In one example the electrophotographic printing process may involve creating an image on a photoconductive surface or photo imaging plate (PIP). The image that is formed on the photoconductive surface is a latent electrostatic image having image and background areas with different potentials. When an electrophotographic pretreatment composition containing charged toner particles is brought into contact with the selectively charged photoconductive surface, the charged toner particles (comprising the solid lubricant) adhere to the image areas of the latent image while the background areas remain clean. The image is then transferred to the polymer film directly, or by first being transferred to an intermediate transfer member (e.g. a blanket) and then to the polymer film.

### Thermoplastic Polymer Resin of an Electrophotographic Pretreatment Composition

Where the pretreatment, an electrophotographic pretreatment composition, the electrophotographic pretreatment composition may comprise a thermoplastic resin. In some examples, the electrophotographic pretreatment composition may be devoid of thermoplastic polymer resin. However, when such resin is present, the thermoplastic resin may be a polymer of an alkylene (e.g. ethylene) and at least one of methacrylic acid or acrylic acid. In some examples, the resin comprises a polymer of ethylene and acrylic acid.

In some examples, the thermoplastic resin comprises a first polymer of an alkylene (e.g. ethylene) and methacrylic acid and a second polymer of alkylene (e.g. ethylene) and acrylic acid. The ratio of the first polymer to the second polymer may be 1:1 to 10:1, for example, 2:1 to 8:1. In one example, ratio of the first polymer to the second polymer may be 3:1 to 6:1, for instance, 4:1 to 5:1. In one example, the electrophotographic pretreatment composition comprises a thermoplastic resin comprising a first copolymer of ethylene and methacrylic acid and a second copolymer of ethylene and acrylic acid. The ratio of the first polymer to the second polymer may be 1:1 to 10:1, for example, 2:1 to 8:1. In one example, ratio of the first polymer to the second polymer may be 3:1 to 6:1, for instance, 4:1 to 5:1. In one example, the first copolymer is a copolymer of ethylene and methacrylic acid sold under the trademark Nucrel® 699 (DuPont). In one example, the second copolymer is a copolymer of ethylene and acrylic acid sold under the trademark AC-5120 (Honeywell®).

In some examples, the thermoplastic resin may be a polymer selected from ethylene or propylene acrylic acid co-polymers; ethylene or propylene methacrylic acid co-polymers; ethylene vinyl acetate co-polymers; co-polymers of ethylene or propylene (e.g. 80 wt % to 99.9 wt %) and alkyl (e.g. C1 to C5) esters of methacrylic or acrylic acid (e.g. 0.1 wt % to 20 wt %); co-polymers of ethylene (e.g. 80 wt % to 99.9 wt %), acrylic or methacrylic acid (e.g. 0.1 wt % to 20.0 wt %) and alkyl (e.g. C1 to C5) esters of methacrylic or acrylic acid (e.g. 0.1 wt % to 20 wt %); co-polymers of ethylene or propylene (e.g. 70 wt % to 99.9 wt %) and maleic anhydride (e.g. 0.1 wt % to 30 wt %); polyethylene; polystyrene; isotactic polypropylene (crystalline); co-polymers of ethylene and ethyl acrylate; polyesters; polyvinyl toluene; polyamides; styrene/butadiene co-polymers; epoxy resins; acrylic resins (e.g. co-polymer of acrylic or methacrylic acid and at least one alkyl ester of acrylic or methacrylic acid wherein alkyl may have from 1 to about 20 carbon atoms, such as methyl methacrylate (e.g. 50% to 90%)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

The resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer, in some examples a polymer having acidic side groups, that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g. Zn, Na, Li) such as SURLYN® ionomers. The polymer comprising acidic side groups can be a co-polymer of ethylene and an ethylenically unsaturated acid of either acrylic or methacrylic acid, where the ethylenically unsaturated acid of either acrylic or methacrylic acid constitute from 5 wt % to about 25 wt % of the co-polymer, in some examples from 10 wt % to about 20 wt % of the co-polymer.

The resin may comprise two different polymers having acidic side groups. The two polymers having acidic side groups may have different acidities, which may fall within the ranges mentioned above. The resin may comprise a first polymer having acidic side groups that has an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 or AC-5180 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

If the resin in the electrophotographic composition comprises a single type of polymer, the polymer (excluding any other components of the electrostatic composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

The resin may comprise two different polymers having acidic side groups that are selected from co-polymers of ethylene and an ethylenically unsaturated acid of either acrylic acid or methacrylic acid; or ionomers thereof, such as methacrylic acid and ethylene-acrylic or methacrylic acid co-polymers which are at least partially neutralized with metal ions (e.g. Zn, Na, Li) such as SURLYN® ionomers. The resin may comprise (i) a first polymer that is a co-polymer of ethylene and an ethylenically unsaturated acid of either acrylic acid and methacrylic acid, wherein the ethylenically unsaturated acid of either acrylic or methacrylic acid constitutes from 8 wt % to about 16 wt % of the co-polymer, in some examples 10 wt % to 16 wt % of the co-polymer; and (ii) a second polymer that is a co-polymer of ethylene and an ethylenically unsaturated acid of either acrylic acid and methacrylic acid, wherein the ethylenically unsaturated acid of either acrylic or methacrylic acid constitutes from 12 wt % to about 30 wt % of the co-polymer, in some examples from 14 wt % to about 20 wt % of the co-polymer, in some examples from 16 wt % to about 20 wt % of the co-polymer in some examples from 17 wt % to 19 wt % of the co-polymer.

The resin may comprise a polymer having acidic side groups, as described above (which may be free of ester side groups), and a polymer having ester side groups. The polymer having ester side groups may be a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1% to 50% by weight of the co-polymer, in some examples 5% to 40% by weight, in some examples 5% to 20% by weight of the co-polymer, in some examples 5% to 15% by weight of the co-polymer. The second monomer may constitute 1% to 50% by weight of the co-polymer, in some examples 5% to 40% by weight of the co-polymer, in some examples 5% to 20% by weight of the co-polymer, in some examples 5% to 15% by weight of the co-polymer. The first monomer can constitute 5% to 40% by weight of the co-polymer, the second monomer constitutes 5% to 40% by weight of the co-polymer, and with the third monomer constituting the remaining weight of the co-polymer. In some examples, the first monomer constitutes 5% to 15% by weight of the co-polymer, the second monomer constitutes 5% to 15% by weight of the co-polymer, with the third monomer constituting the remaining weight of the co-polymer. In some examples, the first monomer constitutes 8% to 12% by weight of the co-polymer, the second monomer constitutes 8% to 12% by weight of the co-polymer, with the third monomer constituting the remaining weight of the co-polymer. In some examples, the first monomer constitutes about 10% by weight of the co-polymer, the second monomer constitutes about 10% by weight of the co-polymer, and with the third monomer constituting the remaining weight of the co-polymer. The polymer may be selected from the Bynel® class of monomer, including Bynel 2022 and Bynel 2002, which are available from DuPont®.

The polymer having ester side groups may constitute 1% or more by weight of the total amount of the resin polymers, e.g. thermoplastic resin polymers, in the liquid electrophotographic composition, e.g. the total amount of the polymer or polymers having acidic side groups and polymer having ester side groups. The polymer having ester side groups may constitute 5% or more by weight of the total amount of the resin polymers, e.g. thermoplastic resin polymers, in some examples 8% or more by weight of the total amount of the resin polymers, e.g. thermoplastic resin polymers, in some examples 10% or more by weight of the total amount of the resin polymers, e.g. thermoplastic resin polymers, in some examples 15% or more by weight of the total amount of the resin polymers, e.g. thermoplastic resin polymers, in some examples 20% or more by weight of the total amount of the resin polymers, e.g. thermoplastic resin polymers, in some examples 25% or more by weight of the total amount of the resin polymers, e.g. thermoplastic resin polymers, in some examples 30% or more by weight of the total amount of the resin polymers, e.g. thermoplastic resin polymers, in some examples 35% or more by weight of the total amount of the resin polymers, e.g. thermoplastic resin polymers, in the liquid electrophotographic composition. The polymer having ester side groups may constitute from 5% to 50% by weight of the total amount of the resin polymers, e.g. thermoplastic resin polymers, in the liquid electrophotographic composition, in some examples 10% to 40% by weight of the total amount of the resin polymers, e.g. thermoplastic resin polymers, in the liquid electrophotographic composition, in some examples 5% to 30% by weight of the total amount of the resin polymers, e.g. thermoplastic resin polymers, in the liquid electrophotographic composition, in some examples 5% to 15% by weight of the total amount of the resin polymers, e.g. thermoplastic resin polymers, in the liquid electrophotographic composition in some examples 15% to 30% by weight of the total amount of the resin polymers, e.g. thermoplastic resin polymers, in the liquid electrophotographic composition.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

The polymer, polymers, co-polymer or co-polymers of the resin can in some examples be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, Bynell 2020 and Bynell 2022, (sold by E. I. du PONT)), the Aclyn family of toners (e.g. Aclyn 201, Aclyn 246, Aclyn 285, and Aclyn 295), and the Lotader family of toners (e.g. Lotader 2210, Lotader, 3430, and Lotader 8200 (sold by Arkema)).

The resin can constitute about 1 to 90%, in some examples about 5 to 80%, by weight of the solids of the liquid electrophotographic pretreatment composition. The resin can constitute about 10 to 70%, in some examples about 30 to 60%, by weight of the solids of the liquid electrophotographic composition.

### Charge Adjuvant of an Electrophotographic Pretreatment Composition

Where the pretreatment composition is an electrophotographic pretreatment composition, the electrophotographic pretreatment composition includes a charge adjuvant. A charge adjuvant may be present with a charge director, and may be different to the charge director, and act to increase and/or stabilise the charge on particles, e.g. resin-containing particles, of an electrostatic composition. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Cu salts of stearic acid, Fe salts of stearic acid, metal carboxylates (e.g. Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock co-polymers of 2-ethylhexyl methacrylate-co-methacrylic acid calcium, and ammonium salts, co-polymers of an alkyl acrylamidoglycolate alkyl ether (e.g. methyl acrylamidoglycolate methyl ether-co-vinyl acetate), and hydroxy bis(3,5-di-tert-butyl salicylic) aluminate monohydrate. In some examples, the charge adjuvant is aluminium di and/or tristearate and/or aluminium di and/or tripalmitate.

The charge adjuvant can constitute about 0.1 to 5% by weight of the solids of the liquid electrophotographic pretreatment composition. The charge adjuvant can constitute about 0.5 to 4% by weight of the solids of the liquid electrophotographic pretreatment composition. The charge adjuvant can constitute about 1 to 3% by weight of the solids of the liquid electrophotographic pretreatment composition.

### Charge Director of an Electrophotographic Pretreatment Composition

Where the pretreatment composition is an electrophotographic pretreatment composition, the electrophotographic pretreatment composition may include a charge director. In some examples, the charge director comprises nanoparticles of a simple salt and a salt of the general formula MAₙ, wherein M is a barium, n is 2, and A is an ion of the general formula [R₁—O—C(O)CH₂CH(SO₃⁻)C(O)—O—R₂], where each of R₁ and R₂ is an alkyl group.

The sulfosuccinate salt of the general formula MAₙ, is an example of a micelle forming salt. The charge director may be substantially free or free of an acid of the general formula HA, where A is as described above. The charge director may comprise micelles of said sulfosuccinate salt enclosing at least some of the nanoparticles. The charge director may comprise at least some nanoparticles having a size of 10 nm or less, in some examples 2 nm or more (e.g. 4-6 nm).

The simple salt may comprise a cation selected from Mg, Ca, Ba, NH₄, tert-butyl ammonium, Li⁺, and Al⁺³, or from any sub-group thereof. In one example, the simple salt is an inorganic salt, for instance, a barium salt. The simple salt may comprise an anion selected from SO₄²⁻, PO³⁻, NO₃⁻, HPO₄²⁻, CO₃²⁻, acetate, trifluoroacetate (TFA), Cl⁻, Bf, F⁻, ClO₄⁻, and TiO₃⁴⁻, or from any sub-group thereof. In some examples, the simple salt comprises a hydrogen phosphate anion.

The simple salt may be selected from CaCO₃, Ba₂TiO₃, Al₂(SO₄)₃, Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiClO₄ and LiBF₄, or any sub-group thereof. In one example, the simple salt may be BaHPO₄.

In the formula [R₁—O—C(O)CH₂CH(SO₃⁻)C(O)—O—R₂], in some examples, each of R₁ and R₂ is an aliphatic alkyl group. In some examples, each of R₁ and R₂ independently is a C₆₋₂₅ alkyl. In some examples, said aliphatic alkyl group is linear. In some examples, said aliphatic alkyl group is branched. In some examples, said aliphatic alkyl group includes a linear chain of more than 6 carbon atoms. In some examples, R₁ and R₂ are the same. In some examples, at least one of R₁ and R₂ is C₁₃H₂₇.

In an electrophotographic composition, the charge director can constitute about 0.001% to 20%, in some examples 0.01 to 20% by weight, in some examples 0.01 to 10% by weight, in some examples 0.01 to 1% by weight of the solids of the electrostatic composition. The charge director can constitute about 0.001 to 0.15% by weight of the solids of the liquid electrophotographic composition, in some examples 0.001 to 0.15%, in some examples 0.001 to 0.02% by weight of the solids of the liquid electrophotographic composition. In some examples, the charge director imparts a negative charge on the electrostatic composition. The particle conductivity may range from 50 to 500 pmho/cm, in some examples from 200-350 pmho/cm.

### Carrier Liquid for an Electrophotographic Pretreatment Composition

Where the pretreatment composition is an electrophotographic pretreatment composition, it may include a carrier liquid. The carrier liquid for the liquid electrophotographic pretreatment composition can act as a dispersing medium for the other components in the electrostatic composition. For example, the carrier liquid can comprise or be a hydrocarbon, silicone oil, vegetable oil, etc. The carrier liquid can include, but is not limited to, an insulating, non-polar, non-aqueous liquid that can be used as a medium for toner particles. The carrier liquid can include compounds that have a resistivity in excess of about 10⁹ ohm-cm. The carrier liquid may have a dielectric constant below about 5, in some examples below about 3. The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquids include, but are not limited to, aliphatic hydrocarbons, isoparaffinic compounds, paraffinic compounds, dearomatized hydrocarbon compounds, and the like. In some examples, the carrier liquid is an isoparaffinic liquid. In particular, the carrier liquids can include, but are not limited to liquids sold under the trademarks, Isopar-G™, lsopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™)

Before printing, the carrier liquid can constitute about 20% to 99.5% by weight of the electrophotographic composition, in some examples 50% to 99.5% by weight of the electrophotographic composition. Before printing, the carrier liquid may constitute about 40 to 90% by weight of the electrophotographic composition. Before printing, the carrier liquid may constitute about 60% to 80% by weight of the electrophotographic composition. Before printing, the carrier liquid may constitute about 90% to 99.5% by weight of the electrophotographic composition, in some examples 95% to 99% by weight of the electrophotographic composition.

The composition when printed on the print substrate, may be substantially free from carrier liquid. In an electrophotographic printing process and/or afterwards, the carrier liquid may be removed, e.g. by an electrophoresis processes during printing and/or evaporation, such that substantially just solids are transferred to the print substrate. Substantially free from carrier liquid may indicate that the composition printed on the print substrate contains less than 5 wt % carrier liquid, in some examples, less than 2 wt % carrier liquid, in some examples less than 1 wt % carrier liquid, in some examples less than 0.5 wt % carrier liquid. In some examples, the composition printed on the print substrate is free from carrier liquid.

### Method of Seaming

As mentioned above, the present disclosure also provides a method of forming a seam between a first region of polymer film and a second region of polymer film. The method comprises pretreating a first region of a polymer film by applying a pretreatment composition comprising solid lubricant particles onto the first region of polymer film; priming the pretreated polymer film with a primer; electrophotographically printing an electrophotographic ink composition onto the primed polymer film to form a printed image; and solvent-bonding the pretreated first region of polymer film to the second region of polymer film to form a seam.

In the method above, the first region may be on a first sheet of polymer film and the second region may be on a second sheet of polymer film. Accordingly, the method of the present disclosure may be used to seal or seam two separate sheets of polymer film together. Alternatively, the first region of polymer film may be on the same sheet of polymer film as the second region of polymer film. In one example, the first region of the polymer film is an edge region of a sheet of polymer film. The second region of the polymer film may be an opposing edge region of the same sheet of polymer film. By seaming the first edge region and second edge region, a sleeve, for example, a shrink sleeve may be formed of the polymer film. The sleeve may be placed over a container (e.g. a bottle) and heat-shrunk to form a heat-shrunk label.

In one example, the polymer film may be a shrink sleeve substrate comprising a sheet of the polymer film. To form the sleeve, an edge region on one face of the sheet may be sealed to an opposing edge region on the opposite face of the sheet.

Where the pretreatment composition is an electrophotographic pretreatment composition, the polymer film may be corona treated before the electrophotographic pretreatment composition is electrophotographically printed onto the polymer film. Corona treatment may improve adhesion of the electrophotographic pretreatment composition on the polymer film.

In one example, the pretreatment composition may be applied prior to the application of a primer. The pretreatment composition includes solid lubricant particles. Thus, when primer is applied over the pretreated regions of the polymer film, adhesion of the primer to the polymer film may be compromised. This may inhibit or prevent the primer from depositing onto the polymer film in the pretreated regions. Thus, when the pretreated region is sealed to a second region of the polymer film by solvent-bonding, a seal may be formed with a reduced risk of primer interfering with the bonding process. This can improve the strength of the seal produced.

In a solvent-bonding process, a seaming solvent may be applied to (at least part of) the pretreated region of the polymer film. The seaming solvent may can soften the polymer, for example, by partially dissolving the polymer molecules in the solvent-treated region. The treated region may then be brought into contact with another region of polymer film and pressure applied to form a seam.

Any suitable seaming solvent may be employed. The precise nature of the solvent may depend on the nature of the film in question.

In some examples, the seaming solvent comprises at least one solvent selected from an ether or a ketone. In some examples, the seaming solvent comprises at least one cyclic ether or cyclic ketone. In some examples, the seaming solvent comprises a cyclic ether having a 3 to 8 membered ring, for example, a 5 or 6 membered ring. The cyclic ether may be a mono- or di-ether. The cyclic ether may have 2 to 6 ring carbons, for example, 3 to 4 ring carbons. In some examples, the seaming solvent comprises a cyclic ketone having a 3 to 8 membered ring, for example, a 5 or 6 membered ring. The cyclic ketone may have up to 8 ring carbons, for example, 5 or 6 ring carbons. Suitable examples include tetrahydrofuran and dioxolane or mixtures thereof. In some examples, the seaming solvent comprises tetrahydrofuran and optionally, dioxolane and/or cyclohexanone.

In one example, a seaming solvent may be applied to the first region once the first region has been pre-treated with the pre-treatment composition. The first region may then be contacted with the second region and pressure applied form a seal. The seaming solvent may only be applied to the pre-treated first region or part of the pre-treated first region. In other words, the seaming solvent may not be applied to areas of the substrate bearing primer or primer and a printed image.

In another example, a seaming solvent may be applied to the second region. The solvent-treated second region may be contacted with the pre-treated first region and pressure applied to form a seal.

### Polymer Film

The polymer film may be any suitable polymer film, for example, a polymer film for manufacturing product packaging or a label for product packaging. Suitable polymers include polypropylene terephthalate glycol PET(G), polyvinyl chloride (PVC), oriented polystyrene film (OPS), expanded polystyrene (EPS) and poly lactic acid (PLA). Other examples include polyethylene (PE) (e.g. linear low density polyethylene (LLDPE) and low density polyethylene (LDPE)); polypropylene (PP) (e.g. biaxially oriented polypropylene (BOPP)), polyethylene terephthalate, and polyamide (e.g. biaxially oriented polyamide).

The polymer film may form part of a laminated composite. The laminate composite may comprise other polymer layers or metal layers.

The film may have any suitable thickness. In some examples, the film may be less than 100 μm in thickness, for example less than 90 μm in thickness, less than 80 μm in thickness, less than 70 μm in thickness, less than 60 μm in thickness, less than 50 μm in thickness, less than 40 μm in thickness, less than 30 μm in thickness, less than 20 μm in thickness, less than 15 μm in thickness. In some examples, the film of material is about 12 μm in thickness.

In some examples, the film may be greater than 12 μm in thickness, for example greater than 15 μm in thickness, greater than 20 μm in thickness, greater than 30 μm in thickness, greater than 40 μm in thickness, greater than 50 μm in thickness, greater than 60 μm in thickness, greater than 70 μm in thickness, greater than 80 μm in thickness, greater than 90 μm in thickness. In some examples, the film of material is about 100 μm in thickness.

The film may be treated by corona treatment, for example, prior to application of any electrophotographic composition. In some examples, the film may be treated by corona treatment prior to application of the electrophotographic pretreatment composition. In some examples, the film may be treated by corona treatment prior to application of the electrophotographic ink composition, which forms a printed image on the polymer film.

### Primer

As discussed above, a primer may be applied to the polymer film, for example, after the first region of the polymer film has been pretreated with the pretreatment composition. The purpose of the primer may be to improve adhesion of printed ink to the polymer film. The primer may be applied to the same face of the polymer film as the face onto which the pre-treatment composition is applied. In some examples, the primer is applied over at least part of the pretreated region. In some examples, the primer does not adhere to the pretreatment composition present on the polymer film. Accordingly, the pretreatment composition may protect the polymer film from contact with the primer in the pretreated regions. In some examples, the primer is applied to the ink-receiving face of the polymer film.

Any suitable primer may be used. Suitable primers include polymeric primers, for example, comprising a polymer and a solvent. In some examples, the primer comprises a polymer emulsion. Suitable solvents include aqueous solvents, for example, water. The concentration of polymer in the solvent may be 5 to 30 weight %, for example, 10 to 15 weight %.

In some examples, the primer may be selected from ethylene acrylic/methacrylic acid or acrylate/methacrylate copolymer emulsions, ethylene acrylic ionomers (saponified acrylic acid), polyamides, polyurethanes, polyamines, polyethylene imines, ethylene vinyl alcohol and ethylene vinyl acetate copolymer emulsions. The primer may also comprise a polymer comprising a polar group. Examples of polar groups include sulfonic, phosphonic, anhydride and silane groups.

In one example, a primer coating comprising a mixture of: a) about 60 to 95% by weight of a copolymer of ethylene and acrylic or methacrylic acid in an aqueous dispersion containing from about 10 to about 40% by weight total solids; and b) about 10 to 40% by weight of an adhesion enhancer comprising a hydrogenated rosin or rosin ester. Examples of such primers are described in U.S. Pat. No. 8,198,353.

In one example, the primer comprises polyethylene imine. In one example, the primer comprises a 1 to 30 weight % (e.g. 5 to 20 weight %) polyethylene imine dissolved in water. In some examples, the primer is a primer sold under the trademark Michelman® DP050 and Michelman® DP050.

The primer may also include at least one of crosslinkers, antifoaming agents, levelling (wetting) agents, and antiblocking agents.

The primer may be applied as a layer in an amount of 0.01 to 5 g/m² of polymer film, for example, 0.02 to 3 g/m² of substrate. In one example, the primer is applied in an amount of 0.03 to 1.5 g/m² of substrate, for example, 0.04 to 1 g/m² of polymer film. In one example, the primer is applied in an amount of 0.05 to 0.8 g/m² of substrate, for example, 0.1 to 0.5 g/m² of polymer film.

The primer may be applied using any suitable method, including painting, dipping, spreading and gravure coating. In one example, the primer is applied by mechanical means. In some examples, the primer is not digitally printed.

In some examples, the primer is an analogue primer that is not suitable for electrophotographic printing. For example, the primer may be devoid of charge adjuvant and/or charge director. The primer may be a non-selective analogue primer, as it may be difficult to target the primer onto selected areas of the substrate by digital printing.

### Electrophotographic Ink Composition

As mentioned above, the polymer film may be printed with an electrophotographic ink composition to form an e.g. visual image on the film after the film has been primed. The electrophotographic ink composition may comprise a colorant and a thermoplastic resin dispersed in a liquid carrier. The electrophotographic ink composition may also include a charge director and/or a charge adjuvant.

The polymer film may be printed prior to seaming. In some examples, the seam is formed between unprinted regions of the polymer film.

Any suitable electrophotographic printing method may be employed. For the electrophotographic printing process may involve creating an image on a photoconductive surface or photo imaging plate (PIP). The image that is formed on the photoconductive surface is a latent electrostatic image having image and background areas with different potentials. When an electrophotographic ink composition containing charged toner particles is brought into contact with the selectively charged photoconductive surface, the charged toner particles adhere to the image areas of the latent image while the background areas remain clean. The image is then transferred to a print substrate (e.g. paper) directly, or by first being transferred to an intermediate transfer member (e.g. a blanket) and then to the print substrate.

### Thermoplastic Resin of an Electrophotographic Ink Composition

As described above, an electrophotographic ink composition may comprise a thermoplastic resin. The thermoplastic resin may be a polymer of an alkylene (e.g. ethylene) and at least one of methacrylic acid or acrylic acid. In one example, the resin may be a polymer of ethylene and acrylic acid.

In some examples, the thermoplastic resin comprises a first polymer of an alkylene (e.g. ethylene) and methacrylic acid and a second polymer of alkylene (e.g. ethylene) and acrylic acid. The ratio of the first polymer to the second polymer may be 1:1 to 10:1, for example, 2:1 to 8:1. In one example, ratio of the first polymer to the second polymer may be 3:1 to 6:1, for instance, 4:1 to 5:1. In one example, the electrophotographic ink composition comprises a thermoplastic resin comprising a first copolymer of ethylene and methacrylic acid and a second copolymer of ethylene and acrylic acid. The ratio of the first polymer to the second polymer may be 1:1 to 10:1, for example, 2:1 to 8:1. In one example, ratio of the first polymer to the second polymer may be 3:1 to 6:1, for instance, 4:1 to 5:1. In one example, the first copolymer is a copolymer of ethylene and methacrylic acid sold under the trademark Nucrel® 699 (DuPont). In one example, the second copolymer is a copolymer of ethylene and acrylic acid sold under the trademark AC-5120 (Honeywell®).

In some examples, the thermoplastic resin may be a polymer selected from ethylene or propylene acrylic acid co-polymers; ethylene or propylene methacrylic acid co-polymers; ethylene vinyl acetate co-polymers; co-polymers of ethylene or propylene (e.g. 80 wt % to 99.9 wt %) and alkyl (e.g. C1 to C5) esters of methacrylic or acrylic acid (e.g. 0.1 wt % to 20 wt %); co-polymers of ethylene (e.g. 80 wt % to 99.9 wt %), acrylic or methacrylic acid (e.g. 0.1 wt % to 20.0 wt %) and alkyl (e.g. C1 to C5) esters of methacrylic or acrylic acid (e.g. 0.1 wt % to 20 wt %); co-polymers of ethylene or propylene (e.g. 70 wt % to 99.9 wt %) and maleic anhydride (e.g. 0.1 wt % to 30 wt %); polyethylene; polystyrene; isotactic polypropylene (crystalline); co-polymers of ethylene and ethyl acrylate; polyesters; polyvinyl toluene; polyamides; styrene/butadiene co-polymers; epoxy resins; acrylic resins (e.g. co-polymer of acrylic or methacrylic acid and at least one alkyl ester of acrylic or methacrylic acid wherein alkyl may have from 1 to about 20 carbon atoms, such as methyl methacrylate (e.g. 50% to 90%)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

The resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer, in some examples a polymer having acidic side groups, that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g. Zn, Na, Li) such as SURLYN® ionomers. The polymer comprising acidic side groups can be a co-polymer of ethylene and an ethylenically unsaturated acid of either acrylic or methacrylic acid, where the ethylenically unsaturated acid of either acrylic or methacrylic acid constitute from 5 wt % to about 25 wt % of the co-polymer, in some examples from 10 wt % to about 20 wt % of the co-polymer.

The resin may comprise two different polymers having acidic side groups. The two polymers having acidic side groups may have different acidities, which may fall within the ranges mentioned above. The resin may comprise a first polymer having acidic side groups that has an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 or AC-5180 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

If the resin in the electrophotographic composition comprises a single type of polymer, the polymer (excluding any other components of the electrostatic composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

The resin may comprise two different polymers having acidic side groups that are selected from co-polymers of ethylene and an ethylenically unsaturated acid of either acrylic acid or methacrylic acid; or ionomers thereof, such as methacrylic acid and ethylene-acrylic or methacrylic acid co-polymers which are at least partially neutralized with metal ions (e.g. Zn, Na, Li) such as SURLYN® ionomers. The resin may comprise (i) a first polymer that is a co-polymer of ethylene and an ethylenically unsaturated acid of either acrylic acid and methacrylic acid, wherein the ethylenically unsaturated acid of either acrylic or methacrylic acid constitutes from 8 wt % to about 16 wt % of the co-polymer, in some examples 10 wt % to 16 wt % of the co-polymer; and (ii) a second polymer that is a co-polymer of ethylene and an ethylenically unsaturated acid of either acrylic acid and methacrylic acid, wherein the ethylenically unsaturated acid of either acrylic or methacrylic acid constitutes from 12 wt % to about 30 wt % of the co-polymer, in some examples from 14 wt % to about 20 wt % of the co-polymer, in some examples from 16 wt % to about 20 wt % of the co-polymer in some examples from 17 wt % to 19 wt % of the co-polymer.

The resin may comprise a polymer having acidic side groups, as described above (which may be free of ester side groups), and a polymer having ester side groups. The polymer having ester side groups may be a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1% to 50% by weight of the co-polymer, in some examples 5% to 40% by weight, in some examples 5% to 20% by weight of the co-polymer, in some examples 5% to 15% by weight of the co-polymer. The second monomer may constitute 1% to 50% by weight of the co-polymer, in some examples 5% to 40% by weight of the co-polymer, in some examples 5% to 20% by weight of the co-polymer, in some examples 5% to 15% by weight of the co-polymer. The first monomer can constitute 5% to 40% by weight of the co-polymer, the second monomer constitutes 5% to 40% by weight of the co-polymer, and with the third monomer constituting the remaining weight of the co-polymer. In some examples, the first monomer constitutes 5% to 15% by weight of the co-polymer, the second monomer constitutes 5% to 15% by weight of the co-polymer, with the third monomer constituting the remaining weight of the co-polymer. In some examples, the first monomer constitutes 8% to 12% by weight of the co-polymer, the second monomer constitutes 8% to 12% by weight of the co-polymer, with the third monomer constituting the remaining weight of the co-polymer. In some examples, the first monomer constitutes about 10% by weight of the co-polymer, the second monomer constitutes about 10% by weight of the co-polymer, and with the third monomer constituting the remaining weight of the co-polymer. The polymer may be selected from the Bynel® class of monomer, including Bynel 2022 and Bynel 2002, which are available from DuPont®.

The polymer having ester side groups may constitute 1% or more by weight of the total amount of the resin polymers, e.g. thermoplastic resin polymers, in the liquid electrophotographic composition, e.g. the total amount of the polymer or polymers having acidic side groups and polymer having ester side groups. The polymer having ester side groups may constitute 5% or more by weight of the total amount of the resin polymers, e.g. thermoplastic resin polymers, in some examples 8% or more by weight of the total amount of the resin polymers, e.g. thermoplastic resin polymers, in some examples 10% or more by weight of the total amount of the resin polymers, e.g. thermoplastic resin polymers, in some examples 15% or more by weight of the total amount of the resin polymers, e.g. thermoplastic resin polymers, in some examples 20% or more by weight of the total amount of the resin polymers, e.g. thermoplastic resin polymers, in some examples 25% or more by weight of the total amount of the resin polymers, e.g. thermoplastic resin polymers, in some examples 30% or more by weight of the total amount of the resin polymers, e.g. thermoplastic resin polymers, in some examples 35% or more by weight of the total amount of the resin polymers, e.g. thermoplastic resin polymers, in the liquid electrophotographic composition. The polymer having ester side groups may constitute from 5% to 50% by weight of the total amount of the resin polymers, e.g. thermoplastic resin polymers, in the liquid electrophotographic composition, in some examples 10% to 40% by weight of the total amount of the resin polymers, e.g. thermoplastic resin polymers, in the liquid electrophotographic composition, in some examples 5% to 30% by weight of the total amount of the resin polymers, e.g. thermoplastic resin polymers, in the liquid electrophotographic composition, in some examples 5% to 15% by weight of the total amount of the resin polymers, e.g. thermoplastic resin polymers, in the liquid electrophotographic composition in some examples 15% to 30% by weight of the total amount of the resin polymers, e.g. thermoplastic resin polymers, in the liquid electrophotographic composition.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

The polymer, polymers, co-polymer or co-polymers of the resin can in some examples be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, Bynell 2020 and Bynell 2022, (sold by E. I. du PONT)), the Aclyn family of toners (e.g. Aclyn 201, Aclyn 246, Aclyn 285, and Aclyn 295), and the Lotader family of toners (e.g. Lotader 2210, Lotader, 3430, and Lotader 8200 (sold by Arkema)).

The resin can constitute about 5 to 99%, in some examples about 50 to 95%, by weight of the solids of the liquid electrophotographic composition. The resin can constitute about 60 to 90%, in some examples about 70 to 85%, by weight of the solids of the liquid electrophotographic composition.

The thermoplastic resin in the electrophotographic ink composition may be the same or different from the thermoplastic resin in the electrophotographic pretreatment composition.

### Charge Adjuvant of an Electrophotographic Ink Composition

The electrophotographic ink composition can include a charge adjuvant. A charge adjuvant may be present with a charge director, and may be different to the charge director, and act to increase and/or stabilise the charge on particles, e.g. resin-containing particles, of an electrostatic composition. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Cu salts of stearic acid, Fe salts of stearic acid, metal carboxylates (e.g. Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock co-polymers of 2-ethylhexyl methacrylate-co-methacrylic acid calcium, and ammonium salts, co-polymers of an alkyl acrylamidoglycolate alkyl ether (e.g. methyl acrylamidoglycolate methyl ether-co-vinyl acetate), and hydroxy bis(3,5-di-tert-butyl salicylic) aluminate monohydrate. In some examples, the charge adjuvant is aluminium di and/or tristearate and/or aluminium di and/or tripalmitate.

The charge adjuvant can constitute about 0.1 to 5% by weight of the solids of the liquid electrophotographic composition. The charge adjuvant can constitute about 0.5 to 4 by weight of the solids of the liquid electrophotographic composition. The charge adjuvant can constitute about 1 to 3% by weight of the solids of the liquid electrophotographic composition.

The charge adjuvant in the electrophotographic ink composition may be the same or different from the charge adjuvant in the electrophotographic pretreatment composition.

### Charge Director of an Electrophotographic Ink Composition

A charge director may be added to the electrophotographic ink composition. In some examples, the charge director comprises nanoparticles of a simple salt and a salt of the general formula MAₙ, wherein M is a barium, n is 2, and A is an ion of the general formula [R₁—O—C(O)CH₂CH(SO₃⁻)C(O)—O—R₂], where each of R₁ and R₂ is an alkyl group.

The sulfosuccinate salt of the general formula MAₙ, is an example of a micelle forming salt. The charge director may be substantially free or free of an acid of the general formula HA, where A is as described above. The charge director may comprise micelles of said sulfosuccinate salt enclosing at least some of the nanoparticles. The charge director may comprise at least some nanoparticles having a size of 10 nm or less, in some examples 2 nm or more (e.g. 4-6 nm).

The simple salt may comprise a cation selected from Mg, Ca, Ba, NH₄, tert-butyl ammonium, Li⁺, and Al⁺³, or from any sub-group thereof. In one example, the simple salt is an inorganic salt, for instance, a barium salt. The simple salt may comprise an anion selected from SO₄²⁻, PO³⁻, NO₃⁻, HPO₄²⁻, CO₃²⁻, acetate, trifluoroacetate (TFA), Cl⁻, Bf, F⁻, ClO₄⁻, and TiO₃⁴⁻, or from any sub-group thereof. In some examples, the simple salt comprises a hydrogen phosphate anion.

The simple salt may be selected from CaCO₃, Ba₂TiO₃, Al₂(SO₄)₃, Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiClO₄ and LiBF₄, or any sub-group thereof. In one example, the simple salt may be BaHPO₄.

In the formula [R₁—O—C(O)CH₂CH(SO₃⁻)C(O)—O—R₂], in some examples, each of R₁ and R₂ is an aliphatic alkyl group. In some examples, each of R₁ and R₂ independently is a C₆₋₂₅ alkyl. In some examples, said aliphatic alkyl group is linear. In some examples, said aliphatic alkyl group is branched. In some examples, said aliphatic alkyl group includes a linear chain of more than 6 carbon atoms. In some examples, R₁ and R₂ are the same. In some examples, at least one of R₁ and R₂ is C₁₃H₂₇.

In an electrophotographic composition, the charge director can constitute about 0.001% to 20%, in some examples 0.01 to 20% by weight, in some examples 0.01 to 10% by weight, in some examples 0.01 to 1% by weight of the solids of the electrostatic composition. The charge director can constitute about 0.001 to 0.15% by weight of the solids of the liquid electrophotographic composition, in some examples 0.001 to 0.15%, in some examples 0.001 to 0.02% by weight of the solids of the liquid electrophotographic composition. In some examples, the charge director imparts a negative charge on the electrostatic composition. The particle conductivity may range from 50 to 500 pmho/cm, in some examples from 200-350 pmho/cm.

The charge director in the electrophotographic ink composition may be the same or different from the charge director in the electrophotographic pretreatment composition.

### Carrier Liquid for an Electrophotographic Ink Composition

The carrier liquid for the liquid electrophotographic ink composition can act as a dispersing medium for the other components in the electrostatic composition. For example, the carrier liquid can comprise or be a hydrocarbon, silicone oil, vegetable oil, etc. The carrier liquid can include, but is not limited to, an insulating, non-polar, non-aqueous liquid that can be used as a medium for toner particles. The carrier liquid can include compounds that have a resistivity in excess of about 10⁹ ohm-cm. The carrier liquid may have a dielectric constant below about 5, in some examples below about 3. The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquids include, but are not limited to, aliphatic hydrocarbons, isoparaffinic compounds, paraffinic compounds, dearomatized hydrocarbon compounds, and the like. In some examples, the carrier liquid is an isoparaffinic liquid. In particular, the carrier liquids can include, but are not limited to liquids sold under the trademarks, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™)

Before printing, the carrier liquid can constitute about 20% to 99.5% by weight of the electrostatic composition, in some examples 50% to 99.5% by weight of the electrostatic composition. Before printing, the carrier liquid may constitute about 40 to 90 by weight of the electrostatic composition. Before printing, the carrier liquid may constitute about 60% to 80% by weight of the electrostatic composition. Before printing, the carrier liquid may constitute about 90% to 99.5% by weight of the electrostatic composition, in some examples 95% to 99% by weight of the electrostatic composition.

The composition when printed on the print substrate, may be substantially free from carrier liquid. In an electrostatic printing process and/or afterwards, the carrier liquid may be removed, e.g. by an electrophoresis processes during printing and/or evaporation, such that substantially just solids are transferred to the print substrate. Substantially free from carrier liquid may indicate that the ink printed on the print substrate contains less than 5 wt % carrier liquid, in some examples, less than 2 wt % carrier liquid, in some examples less than 1 wt % carrier liquid, in some examples less than 0.5 wt % carrier liquid. In some examples, the ink printed on the print substrate is free from carrier liquid.

The carrier liquid in the electrophotographic ink composition may be the same or different from the carrier liquid in the electrophotographic pretreatment composition.

### Colorants of an Electrophotographic Ink Composition

Colorants in the electrophotographic ink composition may be selected from a pigment, dye and a combination thereof. The colorant may be selected from a cyan colorant, a yellow colorant, a magenta colorant and a black colorant. The colorant may be selected from a phthalocyanine colorant, an indigold colorant, an indanthrone colorant, a monoazo colorant, a diazo colorant, inorganic salts and complexes, dioxazine colorant, perylene colorant, anthraquinone colorants, and any combination thereof.

Where present, the colorant may be present in an amount of 0.1 to 10 weight %, for instance, 2 to 5 weight % of the total weight of solids of the composition.

### EXAMPLES

### Example 1—Manufacture of Electrophotographic Pretreatment Composition

An attritor (laboratory 01HD attritor from Union Process (USA)) was charged with 56.15 gr of solid hydrogenated castor oil ((Efka®1920 (BASF)), 0.86 gr of charge adjuvant, aluminium stearate (Sigma-Aldrich®), and 243 gr of Isopar L (Exxon). After grinding for 24 hours at 25° C. the paste was diluted to 2% of solid contain by Isopar L. 8-9 ml of charge director was added to 2 kg of 2% ink dispersion and the mixture was left to stand overnight at room temperature.

### Example 2—Printing

Printing was performed on Indigo 6700 press machine.

A polyethylene terephthalate glycol, PETG, (45 micron) print substrate from Polyplex Corporation was treated by corona (1000 W) in line. A strip (2 cm) of the electrophotographic pretreatment composition of Example 1 was printed along an edge of the corona-treated substrate. The pretreated substrate was then primed across its entire surface using an aqueous solution of polyethylene imine as primer (Michelman® DigiPrime® 050). The primed substrate was then printed using an electrophotographic ink composition comprising a colorant to produce a visual image on the primed substrate surface. However, the electrophotographic ink composition was not printed over the regions of the substrate pretreated with the electrophotographic pretreatment composition of Example 1.

### Example 3—Indicator Test

To demonstrate that the primer did not adhere to the pretreated region of the polymer film, a pH indicator was used to test for the presence of the primer on the printed substrate of Example 2.

The primer was not detected in the pretreated strip (2 cm) along the edge of the substrate. This was the region that was printed with the electrophotographic pretreatment composition of Example 1. In contrast, the indicator turned blue in areas that were not pretreated with the electrophotographic pretreatment composition of Example 1, indicating the presence of the primer in these regions.

### Example 4—Seaming

To seam the printed substrate of Example 2, 1,3 Dioxalane solvent (BASF®) was applied using small piece of cotton on the pretreated (with the pretreatment composition of Example 1) strip (2 cm) along the edge of the substrate. The solvent-treated strip was then attached immediately to the edge of the opposite, un-primed face of the substrate to form a seam.

After several minutes, the seam was tested for delamination. The seam was very strong and the substrate tore during attempts made to delaminate the seam.

### Example 5—Comparative

As a comparison, Example 2 was repeated but without application of the electrophotographic pretreatment composition of Example 1. Accordingly, a PETG (45 micron) print substrate from Polyplex Corporation was treated by corona (1000 W) in line. The substrate was then primed across its entire surface using an aqueous solution of polyethylene imine as primer (Michelman® DigiPrime® 050). The primed substrate was then printed using an electrophotographic ink composition comprising a colorant to produce a visual image on the primed substrate surface. However, the electrophotographic ink composition was not printed over a strip (2 cm) along an edge of the substrate.

To seam the printed substrate, 1,3 dioxolane solvent (BASF®) was applied using small piece of cotton on the strip (2 cm) along the edge of the substrate. The solvent-treated strip was then attached immediately to the edge of the opposite, un-primed face of the substrate to form a seam.

After several minutes, the seam was tested for delamination. The seam was easily delaminated.

### Example 6—“Analogue” Pretreatment Composition

The pretreatment composition was prepared by dissolving solid hydrogenated castor oil ((Efka®1920 (BASF)) in ethyl acetate to form a 5% solution. Complete dissolution was achieved by heating of the material in ethyl acetate at 60° C. with stirring. The warm solution was manually applied to an edge region of a polyethylene terephthalate glycol, PETG, shrink substrate (45 micron) using wick felt. The solvent evaporated immediately from the surface and solid hydrogenated castor oil remained on the substrate as a thin “tail”.

Primer was then applied to the pretreated substrate using an aqueous solution of polyethylene imine as primer (Michelman® DigiPrime® 050). Indicator tests showed the absence of colour in pretreated edge region. This indicated that the primer did not deposit over the solid hydrogenated castor oil.

A seaming test was performed by applying tetrahydrofuran (THF) to the pretreated edge region. The solvent-treated region was then pressed to the non-primed face of the substrate to form a seam. A firm bond was formed.

While the compositions, methods and related aspects have been described with reference to certain examples, those skilled in the art will appreciate that various modifications, changes, omissions, and substitutions can be made without departing from the spirit of the disclosure. It is intended, therefore, that the invention be limited by the scope of the following claims. The features of any dependent claim may be combined with the features of any of the other dependent claims or any and/or any of the independent claims.

1. A method of forming a seam between a first region of polymer film and a second region of polymer film, said method comprising:
pretreating a first region of a polymer film by applying a pretreatment composition comprising solid lubricant particles onto the first region of polymer film;
priming the pretreated polymer film with a primer;
electrophotographically printing an electrophotographic ink composition onto the primed polymer film to form a printed image; and
solvent-bonding the pretreated first region of polymer film to the second region of polymer film to form a seam.

2. A method as claimed in claim 1, wherein the pretreatment composition is applied by electrophotographic printing.

3. A method as claimed in claim 1, wherein the solid lubricant particles comprise at least one fatty acid ester of a polyol.

4. A method as claimed in claim 3, wherein the fatty acid ester is selected from hydrogenated castor oil, glycerol monostearate, pentaerythritol monostearate and pentaerythritol distearate.

5. A method as claimed in claim 1, wherein the polymer film is primed by applying a primer over at least part of the pretreated first region of polymer film.

6. A method as claimed in claim 1, wherein the first region of polymer film is located along an edge of an ink-receiving face of the polymer film, and wherein the second region of polymer film is located along an edge of the opposing face of the polymer film.

7. A method as claimed in claim 1, wherein the first region of the polymer film is solvent-bonded to a second region of the same polymer film to form a sleeve.

8. A method as claimed in claim 7, wherein the method further comprises applying the sleeve to a container and heating the sleeve to shrink the sleeve to the shape of the container.

9. A method as claimed in claim 1, wherein solvent-bonding is carried out by
treating at least a part of the pretreated first region of the polymer film with a seaming solvent, and
subsequently pressing the treated part of the polymer film to the second region of polymer film to form a seam.

10. A method as claimed in claim 8, wherein the seaming solvent is selected from at least on of tetrahydrofuran and dioxolane.

11. An electrophotographic pretreatment composition comprising:
solid lubricant particles comprising at least one fatty acid ester of a polyol,
a charge adjuvant, and
a liquid carrier.

12. A composition as claimed in claim 11, which comprises 70 to 99.5 weight % the solid lubricant particles based on the total weight of solids in the composition.

13. A composition as claimed in claim 11, wherein the fatty acid ester of a polyol is an ester of a C₆-C₂₂ fatty acid and a polyol.

14. A composition as claimed in claim 11, wherein the fatty acid ester of a polyol is an ester of a fatty acid and a polyol selected from glycerol and pentaerythritol.

15. A composition as claimed in claim 11, wherein the fatty acid ester is selected from hydrogenated castor oil, glycerol monostearate, pentaerythritol monostearate and pentaerythritol distearate.
